(19) United States
(12) Patent Application Publication
(10) Pub. No.: US 2007/0236447 A1
(43) Pub. Date: Oct. 11, 2007

(54) Backlight unit using light emitting diode

(75) Inventors: Sang Yun Lee, Suwon (KR); Hyung Suk Kim, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/783,130

(22) Filed: Apr. 6, 2007

(30) Foreign Application Priority Data
Apr. 7, 2006 (KR) 10-2006-0031891
Feb. 21, 2007 (KR) 10-2007-17285

(51) Int. Cl. G09G 3/36

(52) U.S. Cl. 345/102

(57) ABSTRACT

A backlight unit using LEDs in which a plurality of LEDs of different colors used for a surface light source are connected in an electric connection structure incorporating series and parallel connections so that the LEDs of the same color are driven by a single driving circuit, thereby improving the driving efficiency of LEDs. The backlight unit includes a plurality of LED modules each having a plurality of red LEDs, a plurality of green LEDs, and a plurality of blue LEDs electrically connected, respectively. The backlight unit also includes an LED driver composed of a red LED driving circuit, a green LED driving circuit, and a blue LED driving circuit for driving each color group of the plurality of LEDs provided in the LED modules. The plurality of red LEDs, the plurality of green LEDs, and the plurality of blue LEDs in the respective LED modules are electrically connected, respectively.

### CLAIM OF PRIORITY

This application claims the benefit of Korean Patent Application No. 2006-0031891 filed on Apr. 7, 2006 and No. 2007-0017285 filed on Feb. 21, 2007 in the Korean Intellectual Property Office, the disclosures of which are incorporated herein by reference.

### BACKGROUND OF THE INVENTION

1. Field of the Invention

The present invention relates to a backlight unit for a Liquid Crystal Display (LCD) using Light Emitting Diodes (LEDs). More particularly, the invention relates to a backlight unit using LEDs, in which a plurality of LEDs used for a surface light source are connected by an electric connection structure appropriately incorporating series and parallel connections and a plurality of LEDs emitting the same color of light are driven by a single driving circuit, thereby increasing the efficiency in driving the LEDs.

2. Description of the Related Art

A Cold Cathode Fluorescent Lamp (CCFL), which has been used as a light source for the existing LCD backlight unit, is prone to environmental pollution with use of mercury gas, slow in response rate, has low color reproducibility and is inappropriate for miniaturization of an LCD panel. On the other hand, an LED is environmentally friendly, possible in high speed response in nanoseconds, effective for video signal stream and possible in impulsive driving. In addition, it has color reproducibility of over 100% and can be varied in luminance, color temperature, etc. by adjusting the light amounts of red, green and blue LEDs. Moreover, an LED light source is suitable for miniaturization of an LCD panel. Due to these merits, LEDs have been actively adopted as a light source for backlight for LCD panels, etc.

In general, a backlight unit employing LEDs can be distinguished into an edge type and a direct type according to the location of the light source. In the edge type backlight unit, a bar-shaped light source is disposed at a side of a light guide panel and light is irradiated to the surface of the LCD panel through the light guide panel. In the direct type backlight unit, a surface light source having an almost same area as the LCD panel is disposed directly under the LCD panel to irradiate light directly to the surface of the LCD panel.

FIG. 1 is a view illustrating a conventional LCD backlight unit.

Referring to FIG. 1, the conventional direct type backlight unit 100 includes a plurality of LED modules each composed of a plurality of red, blue and green LEDs. In this specification, a ‘red LED’ refers to an LED emitting red light, a ‘green LED’ refers to an LED emitting green light, and a ‘blue LED’ refers to an LED emitting blue light.

The LEDs in a single LED module form series connection structures 111, 112 and 113, respectively, according to colors which the LEDs generate, and the LEDs of the same color connected in series are supplied with driving current from a corresponding one of color LED driving circuits 121, 122 and 123 to emit light.

In the conventional backlight unit, each of the LED modules requires three driving circuits for driving red, green and blue LEDs, respectively. With the increasing number of LED modules, the number of driving circuits for driving the LEDs also increases. For example, given that the number of LED modules is n, the number of LED driving circuits required equals to 3×n.

In the conventional LCD backlight unit 100, each of the LED modules 110 should be equipped with an LED driving unit 120, thus requiring a large number of driving circuits. This increases the number of electronic components constituting the driving circuits, increasing the manufacturing costs of the backlight unit. Furthermore, each of the driving circuits separately produces a driving current for driving the LEDs of the LED modules. Therefore, different magnitudes of driving current are provided to the LEDs in the LED modules, which results in non-uniform light from the LED modules, degrading the image quality of the LCD panel.

### SUMMARY OF THE INVENTION

The present invention has been made to solve the foregoing problems of the prior art and therefore an aspect of the present invention is to provide a backlight unit using LEDs, in which LEDs in a plurality of LED modules are provided with driving current by a common driving circuit, decreasing the number of electronic components and the size of a driving board for mounting the electronic components and a regulated driving current is provided to all of the LED modules to allow uniform light emission of the LED modules, thereby improving the image quality of the LCD panel.

According to an aspect of the invention, the invention provides a backlight unit using Light Emitting Diodes (LEDs). The backlight unit includes a plurality of LED modules each composed of a plurality of red LEDs electrically connected to each other, a plurality of green LEDs electrically connected to each other, and a plurality of blue LEDs electrically connected to each other; an LED driver composed of a red LED driving circuit for driving the plurality of red LEDs provided in the plurality of LED modules, a green LED driving circuit for driving the plurality of green LEDs provided in the plurality of LED modules, and a blue LED driving circuit for driving the plurality of blue LEDs provided in the plurality of LED modules, wherein the plurality of red LEDs in the LED modules are electrically connected with each other, the plurality of green LEDs in the modules are electrically connected with each other, and the plurality of blue LEDs in the LED modules are electrically connected with each other.

Preferably, each of the LED modules is composed of a red LED array including the plurality of red LEDs connected in series, a green LED array including the plurality of green LEDs connected in series, and a blue LED array including the plurality of blue LEDs connected in series.

According to an embodiment of the present invention, the red, green and blue LED arrays in one of the LED modules are connected in parallel with the red, green and blue LED arrays in another one of the LED modules, respectively. In addition, each of the red, green and blue LED arrays in one of the LED modules is connected in series with the red, green and blue LED arrays in another one of the LED modules, respectively. In addition, the red, green and blue LED arrays are connected in series, respectively, in at least two of the LED modules to form red, green and blue LED array series-connection structures, and the red, green and blue LED array series-connection structures are connected in parallel, respectively.

According to another embodiment of the present invention, each of the LED modules is composed of a red LED array group including the plurality of red LED arrays connected in parallel, a green LED array group including the plurality of green LED arrays connected in parallel, and a blue LED array group including the plurality of blue LED arrays connected in parallel. In addition, the red, green and blue LED array groups in one of the LED modules are connected in parallel with the red, green and blue LED array groups in another one of the LED modules, respectively. Moreover, the red, green and blue LED array groups in one of the LED modules are connected in series with the red, green and blue LED array groups in another one of the LED modules, respectively. In addition, the red, green and blue LED array groups are connected in series, respectively, in at least two of the LED modules to form a plurality of red, green and blue LED array group series-connection structures, and the red, green and blue LED array group series-connection structures are connected in parallel, respectively.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating a conventional direct type backlight unit; and

FIGS. 2 to 7 are views illustrating various embodiments of a backlight unit according to the present invention.

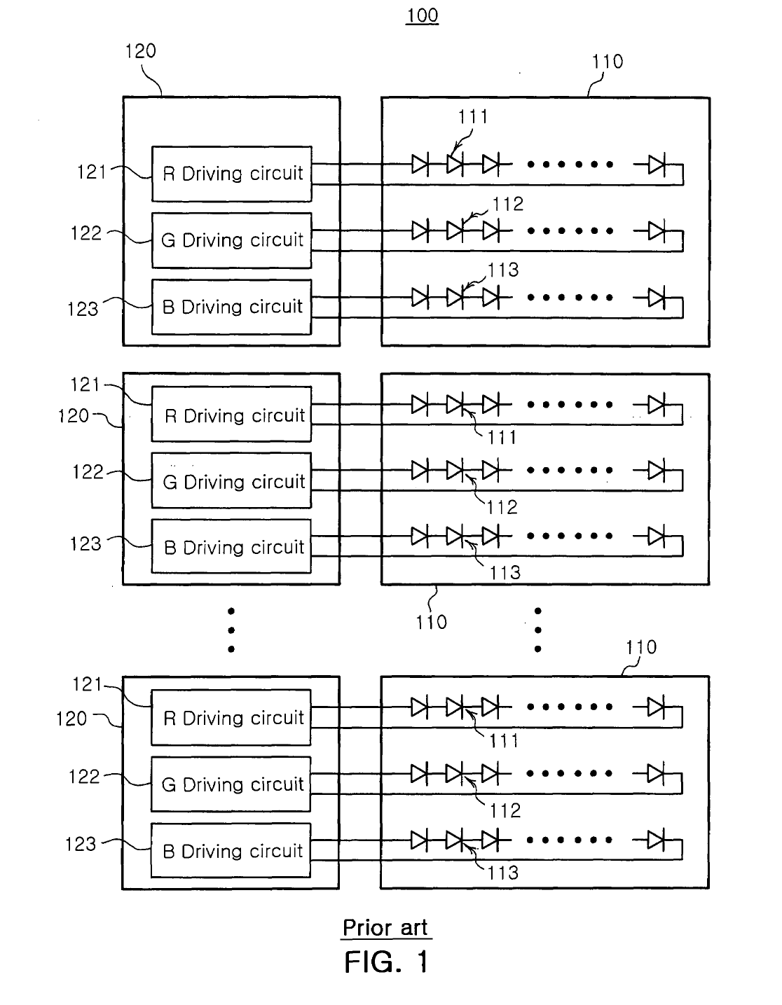

### DETAILED DESCRIPTION OF THE PREFERRED EMBODIMENT

Exemplary embodiments of the present invention will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity and the same reference numerals are used throughout to designate the same or similar components.

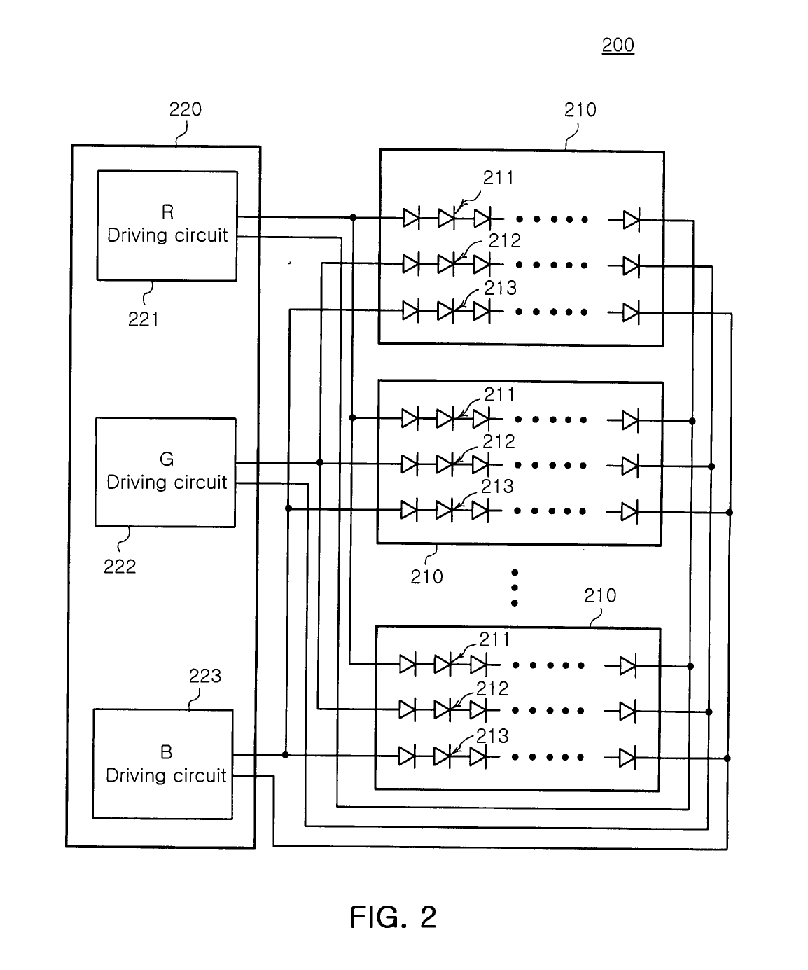

FIGS. 2 to 7 are views illustrating various embodiments of a backlight unit according to the present invention.

First, a backlight unit 200 according to an embodiment shown in FIG. 2 includes a plurality of LED modules 210 each composed of a plurality of red, green and blue LEDs, and a single LED driver 220 for driving the red, green and blue LEDs provided in each of the plurality of LED modules.

Each of the LED modules 210, which incorporates the plurality of red, green and blue LEDs to produce white light, can be a single unit functioning as a surface light source having a predetermined area, and may be composed of a submount such as a substrate with the plurality of red, green and blue LEDs disposed thereon. The red, green and blue LEDs provided in the LED modules can be connected with each other by the same color, respectively, through diverse electric connection structures.

Also in this embodiment, the plurality of red, green and blue LEDs provided in each of the LED modules 210 form a red LED array 211 with the red LEDs connected in series with each other, a green LED array 212 with the green LEDs connected in series with each other, and a blue LED array 213 with the blue LEDs connected in series with each other. In this specification, an ‘LED array’ is defined as a structure in which the same color LEDs are connected in series with each other.

The arrangement of the LEDs of the LED modules exemplified in FIG. 2 is only for explaining the electric connection structure of the LEDs, and in actuality, the LEDs can be arranged in various forms on the submount of the LED modules 210 to produce white light.

In this embodiment, the red, green and blue LED arrays 211, 212 and 213 in one of the LED modules 210 can be connected in parallel with the red, green and blue LED arrays in another one of the LED modules 210, respectively. That is, the red, green and blue LEDs in each of the LED modules 210 form the LED arrays in which the same color LEDs are connected in series with each other, and the same color LED arrays provided in the respective LED modules are connected in parallel with each other.

The LED driver 220 includes a single red LED driving circuit 221 for driving all of the red LED arrays 211 provided in the plurality of the LED modules 210, a single green LED driving circuit 222 for driving all of the green LED arrays 212 in the plurality of the LED modules 210, and a single blue LED driving circuit 223 for driving all of the blue LED arrays 223 in the plurality of the LED modules 210. That is, the red, green and blue LED arrays 211, 212 and 213 provided in each of the LED modules 210 are driven commonly by the single red, green and blue LED driving circuit, respectively.

In this embodiment, the red LED arrays 211 in the plurality of LED modules 210 are connected together to form one connection structure, and the red LEDs in the red LED arrays 211 form one connection structure. The green and blue LED arrays 212 and 213 form respective connection structures in the same fashion, in which the green and blue LEDs in the green and blue LED arrays 212 and 213 form respective connection structures. This allows the red, green and blue LEDs included in the backlight unit 200 to be driven by a single LED driver 220.

Therefore, according to this embodiment, compared to the conventional backlight unit in which each of the LED modules is equipped with a separate driver to drive LEDs, the number of driving circuits can be reduced according to the present invention, thereby reducing the complexity of the entire design of the backlight as well as the number of electronic components used in the backlight unit.

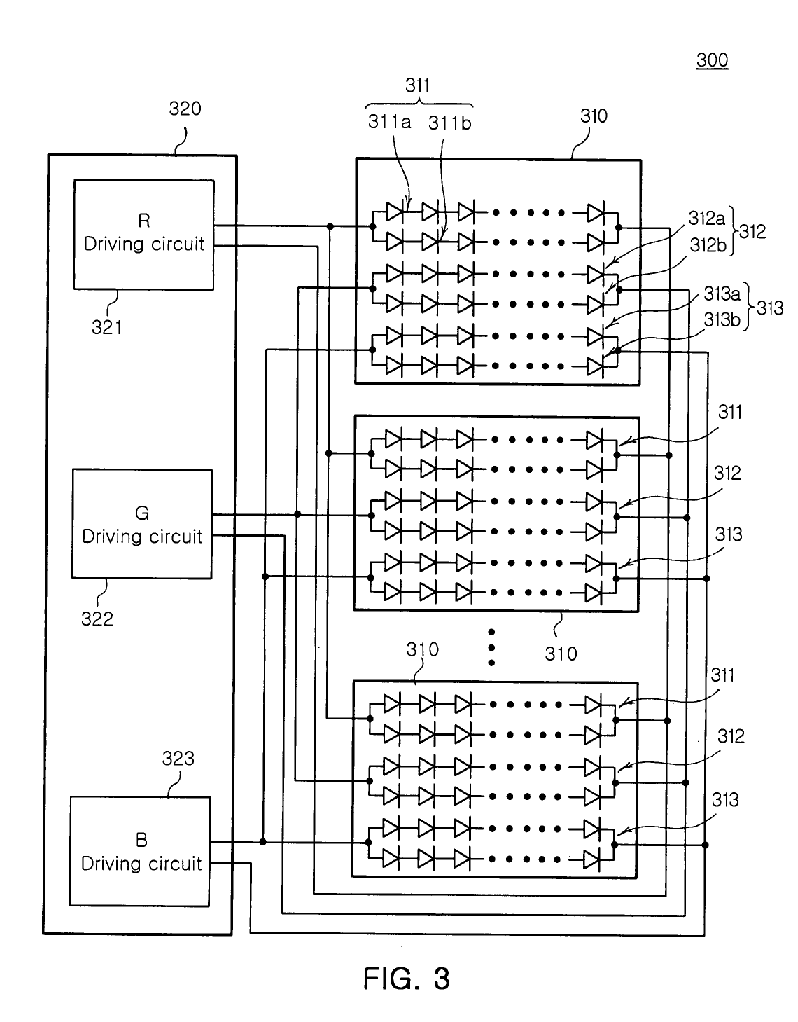

Next, a backlight unit 300 according to an embodiment shown in FIG. 3 includes plurality of LED modules 310 and an LED driver 320 for commonly driving the LEDs provided in the plurality of the LED modules 310.

In this embodiment, each of the plurality of LED modules 310 includes the plurality of red LED arrays 311a and 311b each composed of a plurality of red LEDs connected in series with each other, a plurality of green LED arrays 312a and 312b each composed of a plurality of green LEDs connected in series with each other, and a plurality of blue LED arrays 313a and 313b with a plurality of blue LEDs connected in series with each other. In each of the LED modules 310, a plurality of red LED arrays 311a and 311b are connected in parallel to form a red LED array group 311, a plurality of green LED arrays 312a and 312b are connected in parallel to form a green LED array group, and a plurality of blue LED arrays 313a and 313b are connected in parallel to form a blue LED array group 313. In FIG. 3, the two LED arrays of each color are connected in parallel to form an LED array group of each color, but the present invention is not limited thereto and also includes more than two LED arrays of each color connected in parallel to form an LED array group of each color.

In this embodiment, the red, green and blue LED array groups 311, 312 and 313 in one of the LED modules 310 can be connected in parallel with the red, green and blue LED array groups 311, 312 and 313 in another one of the LED modules 310, respectively. That is, in this embodiment, the red, green and blue LEDs in each of the LED modules 310 are connected in series to form a plurality of LED arrays, and these plurality of LED arrays are connected in parallel to form the LED array groups. Further, the LED array groups of the same color LEDs in the respective LED modules are connected in parallel.

The LED driver 320 includes a single red LED driving circuit 321 for driving the entire red LED array groups 311 included in the LED modules 310, a single green LED driving circuit 322 for driving the entire green LED array groups 312 included in the LED modules 310, and a single blue LED driving circuit 323 for driving the entire blue LED array groups 313 included in the LED modules 310. That is, the red, green and blue LED array groups 311, 312 and 313 included in each of the LED modules 310 can be driven by the single red LED driving circuit, the single green LED driving circuit and the single blue LED driving circuit, respectively. Thus, like the embodiment shown in FIG. 2, this allows reduction of the size of the driving circuit and the number of electronic components used therein.

In general, an LED should be applied with suitable voltages to both electrodes thereof to emit light. Thus, when a plurality of LEDs are connected in series, a voltage corresponding to the suitable voltage for each LED multiplied by the number of LEDs connected in series should be applied to both ends of the LEDs connected in series, in order for all of the LEDs connected in series to emit light altogether. Therefore, given that the number of LED modules and the number of LEDs of each color in each of the LED modules are the same in both of the backlight units in FIGS. 3 and 2, the number of LEDs connected in series in the embodiment shown in FIG. 3 (where two LED arrays form one LED array group) is reduced by half from the number of LEDs connected in series in the embodiment shown in FIG. 2. Therefore, the LED driving circuit of the backlight unit shown in FIG. 3 can be designed to supply 0.5 times the driving voltage necessary for the backlight shown in FIG. 2. Since the driving voltage is reduced by 0.5 times, and the same magnitude of power is required to obtain the same level of brightness, the LED driving circuit of the backlight unit shown in FIG. 3 should be designed to supply two times the driving current supplied to the backlight shown in FIG. 2.

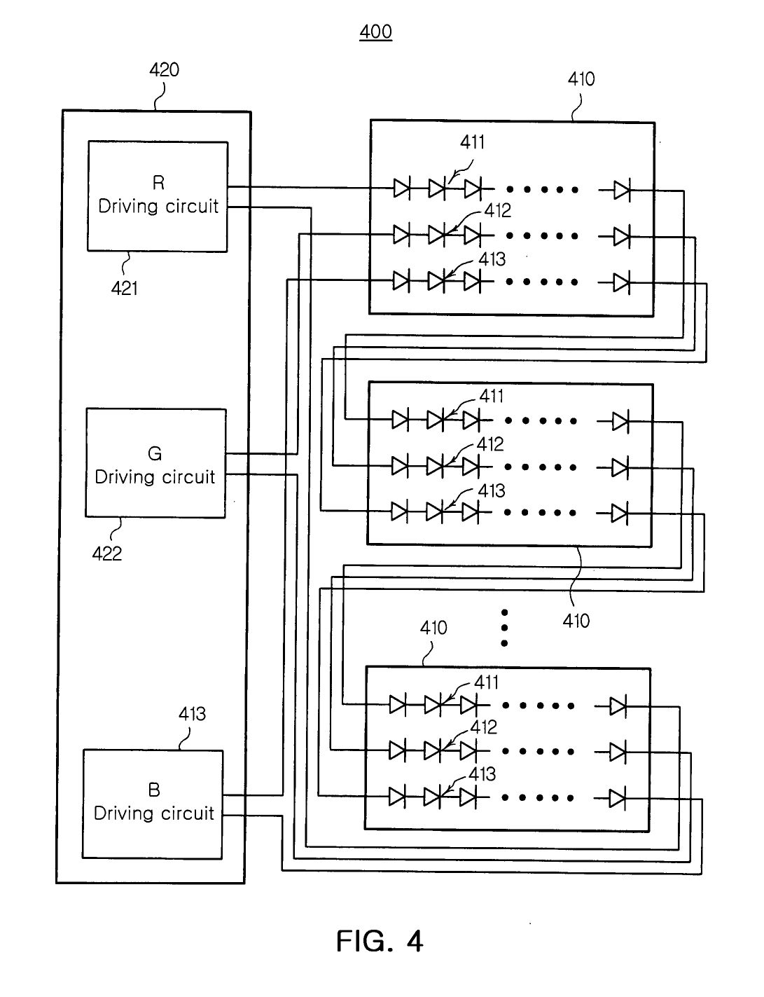

Next, a backlight unit 400 according to an embodiment shown in FIG. 4 includes LED modules 410 and an LED driver 420 with the same LED connection structure as in the embodiment shown in FIG. 2.

In the backlight unit 400 according to this embodiment, a red LED array 411, a green LED array 412 and a blue LED array 413 in one of the LED modules 410 are connected in series with a red LED array 411, a green LED array 412 and a blue LED array 413 in another one of the LED modules 410, respectively. The red, green and blue LED arrays connected in series in all of the LED modules are driven by the red, green and blue LED driving circuits 421, 422 and 423 of the LED driver 420, respectively.

In this embodiment, the number of LED arrays connected in series across the LED modules is equal to the number of LED modules. Therefore, given that the number of LED modules and the number of LEDs in each of the LED modules are the same in both of the backlight units in FIGS. 4 and 2, and with the number of LED modules used in the backlight unit denoted by n, the LED driving circuits 421, 422 and 423 of the backlight unit shown in FIG. 4 has n times greater number of LEDs connected in series than the LED driving circuits shown in FIG. 2. Therefore, the LED driving circuit of the backlight unit shown in FIG. 4 can be designed to supply n times the driving voltage supplied by the LED driving circuit shown in FIG. 2, and 1/n times the driving current supplied by the LED driving circuit shown in FIG. 2 to obtain the same light amount.

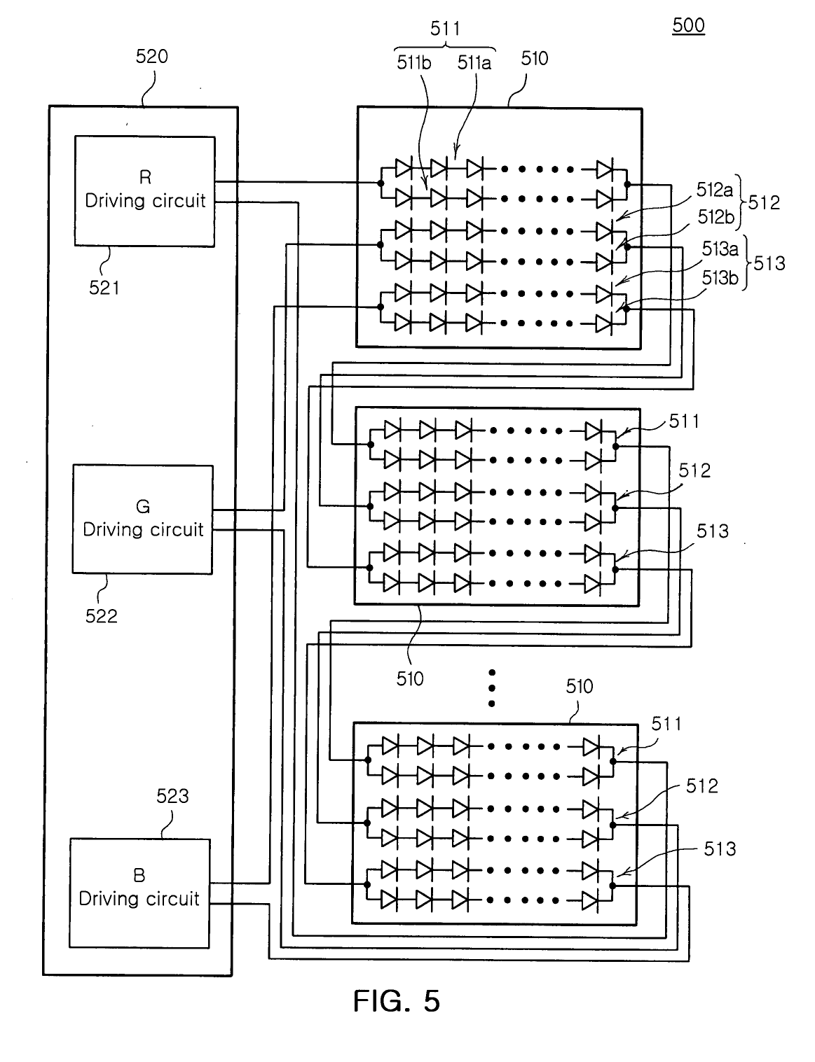

Next, a backlight unit 500 using LEDs according to an embodiment shown in FIG. 5 includes LED modules 510 and an LED driver 520 with the same LED connection structure as in the embodiment shown in FIG. 3.

In the backlight unit 500 according to this embodiment, each of the LED modules 510 includes a plurality of red LED arrays 511a and 511b each with red LEDs connected together in series, a plurality of green LED arrays 512a and 512b each with green LEDs connected together in series, and a plurality of blue LED arrays 513a and 513b each with blue LEDs connected together in series. In addition, the plurality of red LED arrays 511a and 511b are connected in parallel to form a red LED array group 511, the green LED arrays 512a and 512b are connected in parallel to form a green LED array group 512, and the blue LED arrays 513a and 513b are connected in parallel to form a blue LED array group 513.

The red LED array group 511, the green LED array group 512 and the blue LED array group 513 in one of the LED modules 410 are connected in series with the red LED array group 511, the green LED array group 512 and the blue LED array group 513 in another one of the LED modules 410, respectively. The red, green and blue LED array groups connected in series in all of the LED modules are driven by the red, green and blue LED driving circuits 421, 422 and 423 in the LED driver 420, respectively.

In the backlight unit according to this embodiment, the number of LED array groups connected in series is equal to the number of LED modules. Given that the number of LED modules and the number of LEDs of each color in each of the LED modules are the same in both of the backlight units in FIGS. 5 and 2, the number of LEDs connected in series in one LED array in the embodiment shown in FIG. 5 is equal to ½ of the number of red LEDs connected in series in one LED array in FIG. 2. Thus, with the number of LED modules denoted by n, one LED driving circuit in the embodiment shown in FIG. 5 can be designed to supply n/2 times the driving voltage supplied by one LED driving circuit shown in FIG. 2. In addition, in order to provide the same magnitude of power, one LED driving circuit of FIG. 5 can be designed to supply 2/n times the driving current supplied by one LED driving circuit shown in FIG. 2.

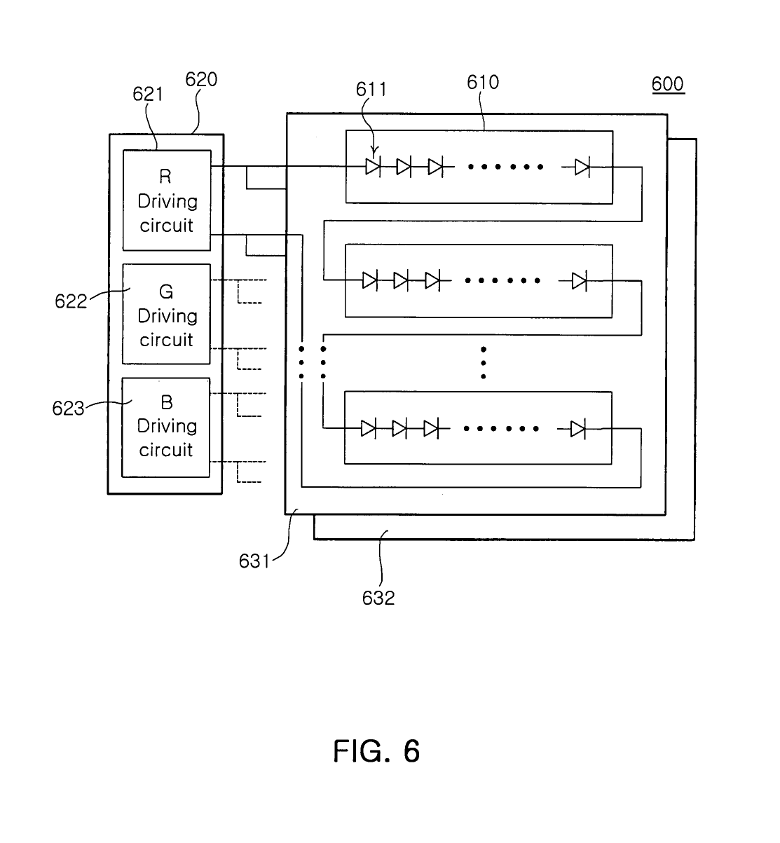

Next, a backlight unit according to an embodiment shown in FIG. 6 includes LED modules 610 and an LED driver 620 having the same LED connection structure as in the embodiment shown in FIG. 2. For the sake of convenience in explanation, only one color LED array is illustrated (for example, red LED array 611), and other color LED arrays are omitted in FIG. 6. However, each of the LED modules should be considered to include a green LED array and a blue LED array as well, which should also be understood to have the same connection structure as explained hereinbelow.

In this embodiment, each color LEDs are connected in series in each of the LED modules 610 to form an LED array 611. The LED array 611 in one of the LED modules is connected in series with another LED array of the same color in at least one other the LED module to form LED array series-connection structures 631 and 632. There are formed at least two of such LED array series-connection structures 631 and 632, and these plurality of LED array series-connection structures 631 and 632 are connected in parallel and driven by the corresponding color LED driving circuit 621 of the LED driver 620.

Given that there are two LED array series-connection structures 631 and 632 in this embodiment as shown in FIG. 6, the comparison between the embodiments shown in FIGS. 2 and 6 is as follows. First, given that the number of LED modules and the number of LEDs in each of the LED modules are the same in both of the embodiments of FIGS. 6 and 2, the number of LEDs connected in series in the LED array shown in FIG. 6 is equal to the number of LEDs connected in series in the LED array shown in FIG. 2. Also, given that two LED array series connection structures are formed (each LED array series-connection structure having the equal number of LED arrays) in FIG. 6, and with the number of LED modules denoted by n, the LED driving circuit in the embodiment shown in FIG. 6 can be designed to supply n/2 times the driving voltage supplied by the LED driving circuit shown in FIG. 2, and to supply 2/n times the driving current supplied by the LED driving circuit shown in FIG. 2 to provide the same magnitude of power.

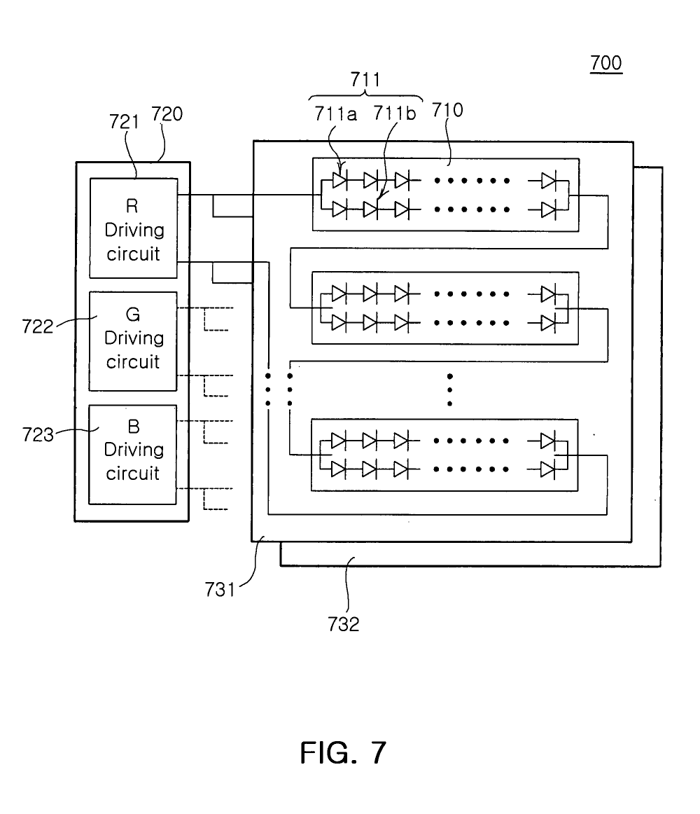

Next, a backlight unit 700 using LEDs according to an embodiment shown in FIG. 7 includes LED modules 710 and an LED driver 720 having the same LED connection structure as shown in FIG. 3. Like in the embodiment shown in FIG. 6, only one color LED array group (for example, red LED array group 711) is illustrated, and other color LED array groups are omitted in FIG. 7 for the sake of convenience in explanation. However, the LED module 710 should be considered to include a green LED array group and a blue LED array group as well, which should be understood to also have the same connection structure as explained hereinbelow.

In this embodiment, each color LEDs included in each of the LED modules 710 are connected in series with each other to form LED arrays 711a and 711b, which in turn are connected in parallel to form an LED array group 711. The LED array group 711 in one of the LED modules is connected in series with the same color LED array group in at least one other LED module to form LED array group series-connection structures 731 and 732. There are formed at least two of such LED array group series-connection structures 731 and 732, and these plurality of LED array group series-connection structures 731 and 732 are connected in parallel and driven by the corresponding color LED driving circuit 721 in the LED driver 720.

As shown in FIG. 7, given that the backlight unit according to this embodiment includes the LED array groups each with two LED arrays, and two LED array group series-connection structures 731 and 732, the comparison between the embodiments shown in FIGS. 2 and 7 is as follows. First, given that the number of LED modules and the number of LEDs in each of the LED modules are the same in both of the embodiments shown in FIGS. 2 and 7, the number of LEDs connected in series in the LED array shown in FIG. 7 is ½ the number of LEDs connected in series in the LED array shown in FIG. 2. Also, given that two LED array group series-connection structures are formed in FIG. 7 (each LED array group series-connection structure having the equal number of LED array groups), and with the number of LED modules denoted by n, the LED driving circuit of FIG. 7 can be designed to supply n/4 times the driving voltage supplied by the LED driving circuit shown in FIG. 2, and to supply 4/n times the driving current supplied by the LED driving circuit shown in FIG. 2 to provide the same magnitude of power.

According to the present invention as set forth above, one driving circuit is used for each color LEDs to simplify a design of the driving circuits and reduce the number of components used in the driving circuits, thereby providing a more economical LCD backlight unit using LEDs.

In addition, the number of driving circuits is reduced to three to reduce the size of a driving board where the driving circuits are installed, thereby reducing the entire size of a product to achieve miniaturization.

Furthermore, the driving circuit is simplified to drive the same color LEDs with one driving circuit, simultaneously regulating the same color LEDs, ultimately improving the image quality.

While the present invention has been shown and described in connection with the exemplary embodiments, it will be apparent to those skilled in the art that modifications and variations can be made without departing from the spirit and scope of the invention as defined by the appended claims.

What is claimed is:

1. A backlight unit using Light Emitting Diodes (LEDs) comprising:
a plurality of LED modules each comprising a plurality of red LEDs electrically connected to each other, a plurality of green LEDs electrically connected to each other, and a plurality of blue LEDs electrically connected to each other;
an LED driver comprising a red LED driving circuit for driving the plurality of red LEDs provided in the plurality of LED modules, a green LED driving circuit for driving the plurality of green LEDs provided in the plurality of LED modules, and a blue LED driving circuit for driving the plurality of blue LEDs provided in the plurality of LED modules,
wherein the plurality of red LEDs in the LED modules are electrically connected with each other, the plurality of green LEDs in the modules are electrically connected with each other, and the plurality of blue LEDs in the LED modules are electrically connected with each other.

2. The backlight unit according to claim 1, wherein each of the LED modules comprises a red LED array including the plurality of red LEDs connected in series, a green LED array including the plurality of green LEDs connected in series, and a blue LED array including the plurality of blue LEDs connected in series.

3. The backlight unit according to claim 2, wherein the red, green and blue LED arrays in one of the LED modules are connected in parallel with the red, green and blue LED arrays in another one of the LED modules, respectively.

4. The backlight unit according to claim 2, wherein each of the red, green and blue LED arrays in one of the LED modules is connected in series with the red, green and blue LED arrays in another one of the LED modules, respectively.

5. The backlight unit according to claim 2, wherein the red, green and blue LED arrays are connected in series, respectively, in at least two of the LED modules to form red, green and blue LED array series-connection structures, and
wherein the red, green and blue LED array series-connection structures are connected in parallel, respectively.

6. The backlight unit according to claim 2, wherein each of the LED modules comprises a red LED array group including the plurality of red LED arrays connected in parallel, a green LED array group including the plurality of green LED arrays connected in parallel, and a blue LED array group including the plurality of blue LED arrays connected in parallel.

7. The backlight unit according to claim 6, wherein the red, green and blue LED array groups in one of the LED modules are connected in parallel with the red, green and blue LED array groups in another one of the LED modules, respectively.

8. The backlight unit according to claim 6, wherein the red, green and blue LED array groups in one of the LED modules are connected in series with the red, green and blue LED array groups in another one of the LED modules, respectively.

9. The backlight unit according to claim 6, wherein the red, green and blue LED array groups are connected in series, respectively, in at least two of the LED modules to form a plurality of red, green and blue LED array group series-connection structures, and
wherein the red, green and blue LED array group series-connection structures are connected in parallel, respectively.
